(19) United States
(12) Patent Application Publication
(10) Pub. No.: US 2026/0035021 A1
(43) Pub. Date: Feb. 5, 2026

(54) VEHICLE TRANSPORTING SYSTEM

(71) Applicant: Terence Layne, Dacula, GA (US)

(72) Inventor: Terence Layne, Dacula, GA (US)

(73) Assignee: Aeridu, LLC, Dacula, GA (US)

(21) Appl. No.: 18/986,215

(22) Filed: Dec. 18, 2024

Related U.S. Application Data
(60) Provisional application No. 63/611,726, filed on Dec. 18, 2023.
(60) Provisional application No. 63/733,404, filed on Dec. 12, 2024.

(51) Int. Cl. B61D 3/18; B60L 7/10; B60L 13/04; B61B 13/08; B61D 47/00

(52) U.S. Cl. CPC B61D 3/181; B60L 7/10; B60L 13/04; B61B 13/08; B61D 47/005

(57) ABSTRACT

A vehicle transporting system is made up of a motor system comprising a magnetic levitation and propulsion system, a transporter body connectable to and moveable by the motor system, and a vehicle coupling system adapted to be coupled one or more vehicles to the transporter body. When one or more vehicles are coupled by the vehicle coupling system to the transporter body, the transporter body and the one or more vehicles can be transported from one location to another location by the motor system.

### PRIORITY

The present application claims the benefit of domestic priority based on U.S. Provisional Patent Application 63/611,726 filed on Dec. 18, 2023 and U.S. Provisional Patent Application 63/733,404, filed on Dec. 12, 2024, the entireties of both of which are incorporated herein by reference.

### BACKGROUND

Improvements in transportation are of paramount importance in today's world. Congestion on highways leads to numerous problems ranging from personal inconveniences, such as time delays during traffic slowdowns, to physical and structural damage, such as the damage resulting from traffic accidents, to global and environmental issues, such as carbon emissions that result from vehicles the the effects thereof.

In the transportation industry, several attempts have been made to help reduce traffic congestion. One of the most common solutions to the problem is the use of alternative transit systems, such as mass transit. Trains, buses, airplanes, and similar transportation systems have been used for more than a century to shuttle individuals from one location to another. However, these systems suffer from the disadvantage that a user of the system arrives at a destination without his or her automobile or other personal vehicle. Thus, a traveler arriving at a destination, must rent or borrow a vehicle, make arrangements for local travel, use local mass transit, use a taxi or rideshare service, walk, or the like in order to get around at the destination. To be able to use one's own automobile at a destination, the best solution has always been to drive it to the destination.

This desire to have one's own automobile at a travel destination has led to increasingly congested highways. The increase in the number of cars on the highways causes traffic hazards and delays, and it increases pollution, contributes to climate change, and depletes the planet's fossil fuels. One solution has been the creation of lighter and more fuel-efficient automobiles. However, as weight is reduced, often safety is reduced as well, and the risk of being in a severe accident increases. Another solution has been the advent of electric vehicles that do not directly use fossil fuels or produce harmful emissions. However, these electric vehicles are limited in the electrical charge they are capable of holding and thus require frequent stops for recharging which can significantly delay a trip. Also, there are other disadvantages with driving a vehicle to a destination, such as the attention the driver must pay to operate the vehicle instead of relaxing and the wear and tear on the vehicle.

There is therefore a need for an improved transportation system. There is further a need for an improved transportation system that transports a vehicle, such as an automobile, without it having to be driven. There is a further need for a transportation system that transports a vehicle with a reduced impact on the environment. There is a further need for a transportation system that transports a vehicle to a destination while reducing the number of vehicles on the highway.

### SUMMARY

The present invention satisfies these needs. In one aspect of the invention, an improved transportation system is provided.

In another aspect of the invention, an improved transportation system includes a vehicle transporting system.

In another aspect of the invention, an improved transportation system includes a transporting system for transporting one or more vehicles.

In another aspect of the invention, a transportation system is provided that transports a vehicle without it having to be driven.

In another aspect of the invention, a transportation system is provided that transports a vehicle with a reduced impact on the environment.

In another aspect of the invention, a transportation system is provided that transports a vehicle to a destination while reducing the number of vehicles on the highway.

In another aspect of the invention, a vehicle transporting system comprises a motor system and a vehicle coupling system.

In another aspect of the invention, a vehicle transporting system comprises a magnetic levitation motor system and a vehicle coupling system.

In another aspect of the invention, a vehicle transporting system comprises a motor system and a vehicle coupling system, the motor system comprising a guideway system comprising a guideway rail and a moving member that moves along the guideway rail.

In another aspect of the invention, a method of transporting a vehicle comprises coupling a vehicle to a vehicle transporting system as disclosed herein.

In another aspect of the invention, a method of method of transporting a vehicle comprises providing a vehicle transportation system as described herein and using the vehicle transportation system as described herein.

In another aspect of the invention, a vehicle transporting system comprises a motor system comprising a magnetic levitation and propulsion system; a transporter body connectable to and moveable by the motor system; and a vehicle coupling system adapted to be coupled one or more vehicles to the transporter body, wherein when one or more vehicles are coupled by the vehicle coupling system to the transporter body, the transporter body and the one or more vehicles can be transported from one location to another location by the motor system.

In another aspect of the invention, a method of transporting a vehicle comprises providing a vehicle transportation system comprising a motor system comprising a magnetic levitation and propulsion system; a transporter body connectable to and moveable by the motor system; and a vehicle coupling system adapted to be coupled one or more vehicles to the transporter body; coupling a vehicle to the transporter body using the vehicle coupling system; and causing the motor system to move the transporter body and the vehicle coupled to the transporter body from a first location to a second location.

In another aspect of the invention, a method of transporting a vehicle comprises driving a vehicle to a first transfer station; coupling the vehicle to a transporter body; moving the transporter body by a magnetic levitation motor system from the first transfer station to a second transfer station; decoupling the vehicle from the tranporter body; and driving the vehicle away from the second transfer station.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic, partially sectional front view of a version of a vehicle transporting system of the invention;

FIG. 1B is a schematic top view of the vehicle transporting system of FIG. 1A;

FIG. 2A is a schematic, partially sectional front view of another version of a vehicle transporting system of the invention;

FIG. 2B is a schematic, partially sectional front view of another version of a vehicle transporting system of the invention;

FIG. 2C is a schematic, partially sectional front view of another version of a vehicle transporting system of the invention;

FIG. 3 is a schematic, partially sectional front view of a version of a transporting system for a vehicle transporting system of the invention;

FIG. 4 is a schematic, partially sectional top view of a version of a transporting system for a vehicle transporting system of the invention;

FIG. 5 is a schematic, front, partially sectional view of a version of a vehicle transporting system of the invention;

FIG. 6 is a schematic perspective view from the front and above of a version of a vehicle transporting system of the invention;

FIG. 7 is a schematic bottom view of a version of a vehicle transporting system of the invention;

FIG. 8A is a schematic perspective rear view of a portion of a version of a vehicle transporting system of the invention;

FIG. 8B is a perspective view of a portion of a vehicle transporting system of the invention;

FIG. 8C is a schematic perspective front and side view of version of a vehicle transporting system of the invention;

FIG. 9 is a schematic perspective front view of another version of a vehicle transporting system of the invention;

FIG. 10 is a schematic perspective front and side view of another version of a vehicle transporting system of the invention;

FIG. 11 is a schematic perspective front view of another version of a vehicle transporting system of the invention;

FIG. 12A is a schematic perspective front view of another version of a vehicle transporting system of the invention;

FIG. 12B is a schematic perspective front view of another version of a vehicle transporting system of the invention;

FIG. 13A is a schematic perspective front and side view of another version of a vehicle transporting system of the invention;

FIG. 13B is a schematic perspective rear view of the vehicle transporting system of FIG. 13A; and

FIG. 14 is a schematic perspective front view of another version of a vehicle transporting system of the invention.

### DESCRIPTION

The present invention relates to a transportation system. In particular, the invention relates to a vehicle transporting system. Although the vehicle transporting system is illustrated and described in the context of being useful for transporting vehicles, such as automobiles, and/or passengers in a driverless manner, the present invention can be useful in other instances. Accordingly, the present invention is not intended to be limited to the examples and embodiments described herein.

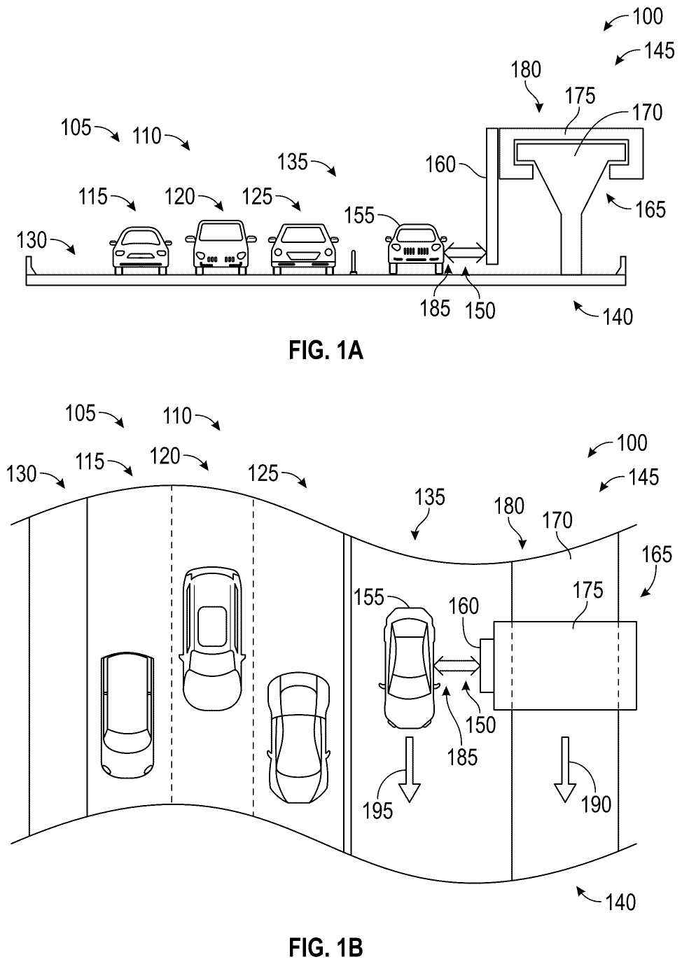

FIGS. 1A and 1B show front and top views, respectively, of a version of a vehicle transporting system 100 according to the invention. In this version, the vehicle transporting system 100 is provided on or near a highway 105 or other road.

Alternatively, the vehicle transporting system 100 can be positioned somewhere other than a highway, such as near a railroad, power lines, canal, and/or the like. In the highway version of FIGS. 1A and 1B, one or more lanes 110 of the highway 105 are dedicated for the vehicle transporting system 100. For example, in the particular version shown, the highway includes a right-hand lane 115 which is often considered a staging lane and is used for entering and exiting the highway 105 and/or for slower traffic. Sometimes one or more intermediate lanes 120 are provided for through traffic, and a passing lane 125 to the left of the intermediate lanes 120 is for passing and/or very fast traffic. Optionally, a shoulder 130 area is provided for when vehicles need to pull over to get out of the flow of traffic. A vehicle transporting system lane 135 is provided, in the version shown, to the left of the passing lane 125. Often, this vehicle transporting system lane 135 will be in a median 140 region that separates the highway 105 into lanes for traffic traveling in a first direction from lanes for traffic traveling in a second, opposite direction. Alternatively, the vehicle transporting system lane 135 can be along the shoulder 130 or elsewhere on the highway 105.

As shown in FIGS. 1A and 1B, the vehicle transporting system 100 comprises a motor system 145, a vehicle coupling system 150 that selectively couples to a vehicle 155, and a transporter body 160 that connects the motor system 145 to the vehicle coupling system 150 and allows the vehicle coupling system 150 and a vehicle 155 coupled thereto to be transported by the motor system 145 to a destination. The motor system 145 comprises a guideway system 165 made up of a stationary guideway rail 170 and a moving member 175 that moves along and relative to the guideway rail 170. The motor system 145 also comprises a propulsion system 180 that is adapted to cause the moving member 175 to move along and/or relative to the stationary guideway rail 170. The vehicle coupling system 150 is attached to, connectable to, and/or an integral part of the transporter body 160, and includes a coupling mechanism 185 adapted to couple to one or more vehicles 155 so that the one or more vehicles 155 are coupled to and transportable via the transporter body 160 which is coupled to or coupleable to the moving member 175 of the motor system 145 so that it moves therewith. Accordingly, when one or more vehicles 155 are coupled by the vehicle coupling system 150 to the transporter body 160, the transporter body 160 and the one or more vehicles 155 can be transported from one location to another location by the vehicle transportating system 100. The guideway rail 170 extends along a length to be travelled, such as along or substantially parallel to at least a length of the highway 105. The propulsion system 180 is capable of causing the moving member 175 to move along and/or relative to the guideway rail 170 in a direction of travel 190. The transporter body 160 is rigidly connected to, or itself forms at least a part of, the moving platform 175 so that the transporter body 160 travels along the guideway rail 170 along with the moving member 175 in the direction of travel 190. The coupling mechanism 185 selectively engages with and couples one or more vehicles 155 to the transporter body 160 so that the one or more vehicles 155 can be transported alongside the guideway rail 170.

In use, the vehicle transporting system 100 transports a vehicle 155 from a first point or on-boarding location along the guideway system 165 to a second point or destination or off-boarding location along the guideway system 165. In transit between the on-boarding and off-boarding locations, the one or more vehicles 155 are coupled to the vehicle transporting system 100, and the vehicle transporting system 100 causes and directs the movement of the one or more vehicles 155 so that the one or more vehicles 155 do not have to be driven or even occupied. The one or more vehicles 155 are caused to move in a vehicle direction of travel 195 that corresponds to the direction of travel 190 of the moving member 175. In a first version of use, a user, such as a driver or owner of a vehicle 155, will drive the vehicle 155 or cause the vehicle 155 to be driven to the on-boarding location where the vehicle 155 can be coupled to the vehicle transporting system 100 by the vehicle coupling system 150. The user and optionally one or more passengers will then sit idly in the vehicle 155 while the vehicle 155 is transported by the vehicle transporting system 100 to the off-boarding location, such as a second transfer station, at which point the vehicle 155 can be decoupled from the vehicle coupling system 150 and the user can again resume driving the vehicle 155 or causing the vehicle 155 to be driven in usual fashion. In a second version of use, the user can get out of the vehicle 155 and allow the vehicle 155 to be transported on its own to the off-boarding location. The user can either meet the vehicle 155 at the off-boarding location or a different individual can assume responsibility for the vehicle 155 once it is off-boarded. By vehicle it is meant any type of vehicle capable of containing or carrying one or more individuals and capable or being driven directly, indirectly, remotely, autonomously, or the like, and includes by way of non-exhaustive examples an automobile, a car, a truck, a van, an SUV, an ATV, a bicycle, a motorcycle, a snowmobile, a tractor, a tractor trailer, a bus, an ambulance, a firetruck, a mail delivery vehicle, a cargo trailer, a water tanker, a military vehicle, a rescue vehicle, a recreational motor home, an executive motor coach, and the like.

By using the vehicle transportating system 100, a user or users can travel from one point to another in an advantageous manner. For example, the user can travel to a destination and have access to the user's vehicle 155 while at the destination but without having to physically drive the vehicle 155 to the destination or at least to the off-boarding location. The vehicle 155 will not have to directly use any fuel which will save the individual fuel cost. There will be no direct emissions from the vehicle 155 which will help protect the environment. There will be less wear and tear on the vehicle 155 thereby increasing its life of the vehicle 155. There will be a highly reduced risk of accidents thereby making the travel safer for the user and the user's passengers. In addition, the user can be transported while relaxing or working and not have to concentrate on driving.

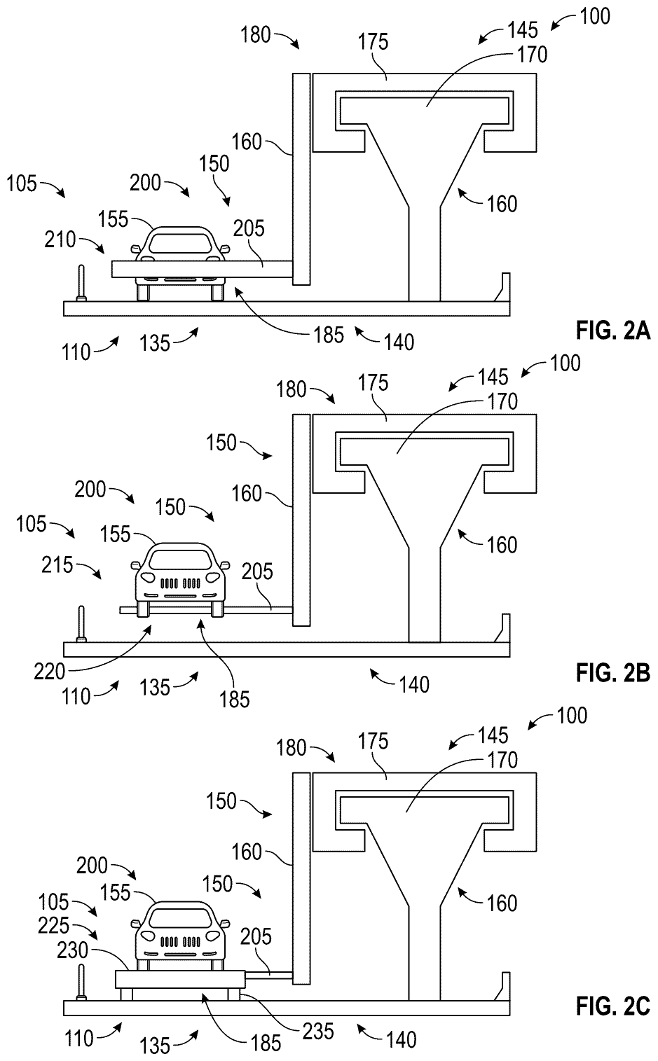

FIGS. 2A, 2B, and 2C show versions of vehicle coupling systems 150 for the vehicle transporting system 100 of the version of FIGS. 1A and 1B. In the version of FIG. 2A, the vehicle coupling system 150 is a tow coupling system 200. In this version, the coupling mechanism 185 of the tow coupling system 200 has a coupling arm 205 that extends from the transporter body 180. The coupling arm 205 includes a latching mechanism 210 that is adapted to latch onto the front of the vehicle 155 or elsewhere on the vehicle 155. In motion, the vehicle 155 is placed in neutral so that wheels of the vehicle 155 freely turn, and the tow coupling system 200 pulls or tows the vehicle 155 in the direction of travel 195. Optionally, the tow coupling system 200 can include a lift system to lift two of the wheels of the vehicle 155 off the ground, in a similar manner to a tow truck. In use, a user drives the vehicle 155 to an on-boarding location and positions the vehicle 155 in position in proximity to the coupling mechanism 185. The coupling arm 205 is then coupled to the vehicle 155 automatically or manually, and the vehicle 155 is placed in neutral and the engine turned off. The user can then leave the vehicle 155 or ride along to the off-boarding location.

In the version of FIG. 2B, the vehicle coupling system 150 is an elevating coupling system 215. In this version, the elevating coupling system 215 includes a coupling arm 205 that includes an elevating mechanism 220 that raises the entirety of the vehicle 155 off the ground. The elevating mechanism 220 then carries the vehicle 155 off the ground as the transporter body 160 and the moving member 175 are propelled in the direction of travel 190. In this version, the wheels of the vehicle 155 do not spin which reduces an additional amount of wear and tear. In use, a user drives the vehicle 155 to an on-boarding location and positions the vehicle 155 in position in proximity to the coupling system 150. The elevating mechanism 220 then elevates the vehicle 155. The user can then leave the vehicle 155 or ride along to the off-boarding location.

In the version of FIG. 2C, the vehicle coupling system 150 is a vehicle supporting system 225. The vehicle supporting system 225 includes a vehicle support platform 230 that travels with the transporter body 160 and the moving member 175 as they are propelled in the direction of travel 190. The support platform 230 can include wheels 235 or the like that roll as the support platform 230 moves and carries the vehicle 155. Alternatively, the support platform 230 can slide on rails or be supported above rails or the like. In use, a user drives the vehicle 155 to an on-boarding location and positions the vehicle 155 in position in proximity to the vehicle coupling system 150. The vehicle 155 is then placed on the support platform 230, such as by driving it up a ramp, and is secured thereto. The user can then leave the vehicle 155 or ride along to the off-boarding location.

Optionally, the vehicle coupling system 150 is equipped with an electric vehicle charging cable so that an electric vehicle can be charged during its transport from the on-boarding location to the off-boarding location.

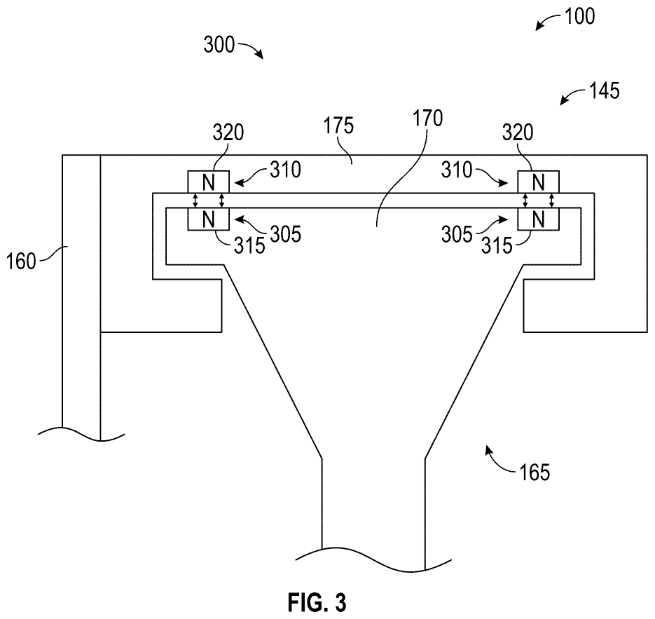

In one version, as shown in FIG. 3, the motor system 145 of the vehicle transporting system 100 comprises a magnetic levitation system 300, also known as a maglev system. With the magnetic levitation system 300, the moving member 175 is levitated above or otherwise in relation to the guideway rail 170 by the use of magnetic force. As conceptually shown schematically in FIG. 3, a guideway rail magnetic system 305 interacts with a moving member magnetic system 310 to cause the moving member 170 to levitate above the guideway rail 170. The guideway rail magnetic system 305 includes one or more guideway levitation magnetic field generators 315, and the moving member magnetic system 310 comprises one or more moving member levitation magnetic field generators 320 that interact with the guideway levitation magnetic field generators 315. Like pole magnetic fields repel one another, such as by both being illustrated as north pole magnets in the example of FIG. 3. Accordingly, when the magnetic fields of the guideway rail magnetic system 305 and the moving member magnetic system 310 are sufficiently strong and interact with one another, the moving member 175 is suspended above the guideway rail 170. Multiple sets of magnetic interactions can be spaced around the moving member 175 and the guideway rail 170 to provide horizontal stability and to accommodate off-center weight that is being carried.

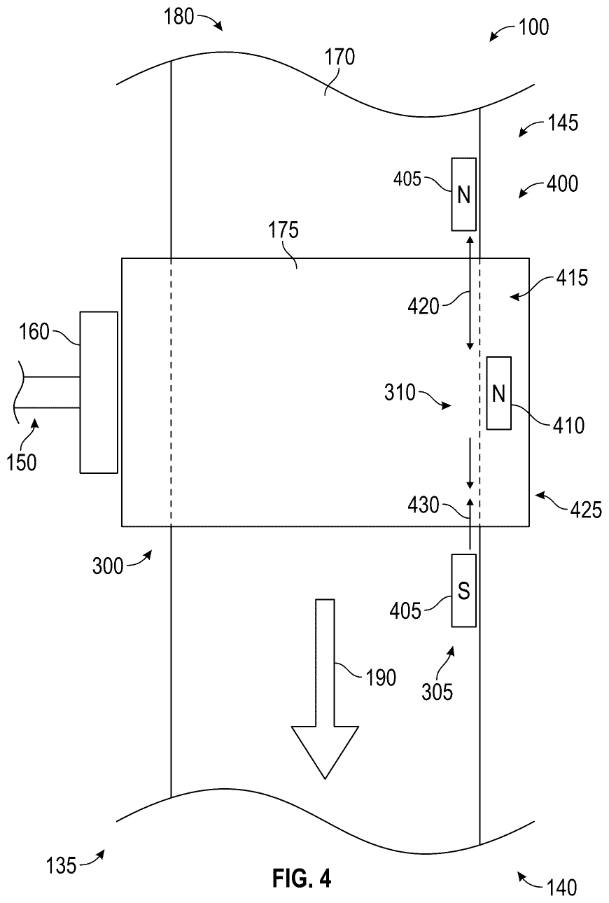

FIG. 4 illustrates how the magnetic levitation system 300 also serves to cause the moving member 175 to move along the guideway rail 170. In this regard, the propulsion system 180 comprises a magnetic levitation propulsion system 400. With the magnetic levitation propulsion system 400, the guideway rail magnetic system 305 comprises a series of guideway rail propulsion magnetic field generators 405. The moving member magnetic system 310 comprises one or more moving member propulsion magnetic field generators 410. The propulsion magnetic field generators 410 interact with the guideway rail propulsion magnetic field generators 405 to cause the levitated moving member 175 to move along the guideway rail 170. As shown in simplified form in FIG. 4, a first magnetic field 415 interaction can be generated from like pole magnets. These like pole magnets repel one another 420 which urges the moving member 175 in the direction of travel 190. A second magnetic field 425 interaction can be generated from opposite pole magnets. The opposite pole magnets attract one another 430 which also urges the moving member 175 in the direction of travel 190. Reversing the polarity of the guideway rail propulsion magnetic fields 405 with urge the moving member 175 in the opposite direction, thus allowing it to slow down or stop when it is moving in the direction of travel 190 or to make the moving member 175 move along the guideway rail in a direction opposite to the direction of travel 190.

The magnetic fields of the magnetic levitation system 300 and the magnetic levitation propulsion system 400 are arranged around and along the guideway rail 170 and the moving member 175 and are controlled by electrical current applied to one or both of the magnets of the moving member 175 and the magnet of the guideway rail 170. A control system is thus able to control the levitation, the horizontal stability, and the propulsion by altering the magnetic field strengths in a certain and predetermined manner. Typically, the magnets used are superconducting magnets that are cooled to extremely low temperatures in order to generate the magnetic fields of sufficient strength to levitate the moving platform 170, as is known in the art from the use of maglev systems in high speed trains across the world. The magnetic levitation propulsion system 400 is often referred to as a linear motor. As in known in the art and will be appreciated, the magnetic levitation system 300 and/or magnetic levitation propulsion system 400 can use an electromagnetic suspension system or an electrodynamic suspension system, as is known for their use high speed trains and the like.

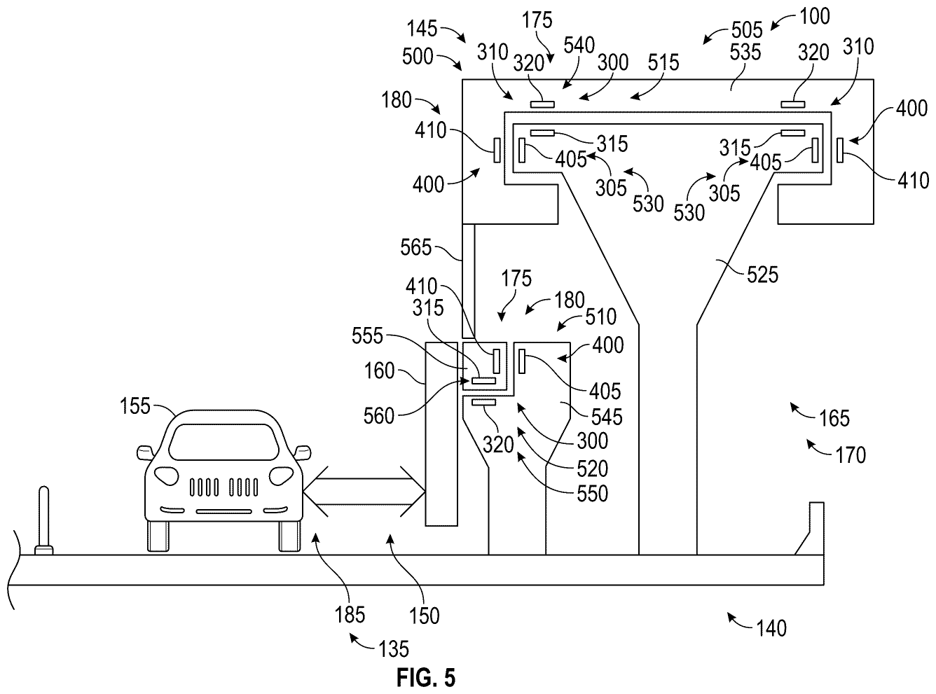

In one version, as shown in FIG. 5, the motor system 145 of the vehicle transporting system 100 comprises a plurality of motors, propulsion systems, or the like. For example, in the version shown, the motor system 145 is a multi-motor system 500 that comprises a first magnetic levitation motor 505 and a second magnetic levitation motor 510. In this version, the first magnetic levitation motor 505 is a high-speed motor that is adapted to move the transporter body 160 and any vehicles coupled to the transporter body 160 at a relatively high speed over a long distance. The second magnetic levitation motor 510 is a low-speed motor that is has a top speed less than the first magnetic levitation motor 505. The second magnetic levitation motor 510 is adapted to move the transporter body 160 over shorter distances and/or in areas where the speed of the vehicle transporting system 100 is reduced. For example, when transporter body 160 is pulling into or out of a transfer station, the transporter body 160 can be at least predominantly under the control of the second magnetic levitation motor 510, and when the transporter body 160 is traveling at a higher rate of speed between transfer stations, the transporter body 160 can be at least predominantly under the control of the first magnetic levitation motor 505. The first magnetic levitation motor 505 and the second magnetic levitation motor 510 can be either a linear induction motor a linear synchronous motor. Optionally, a third or more motor can also be provided. The plurality of motors can be used to accommodate special terrain as required, such as mountains, or to achieve higher speeds.

As shown in the version of FIG. 5, each of the first magnetic levitation motor 505 can comprise a first magnetic levitation system 515, and the second levitation motor 510 can comprise a second magnetic levitation system 520 separate and independently operable from the first magnetic levitation system 515. The first magnetic levitation motor 505 comprises a first guideway rail 525 that includes a first guideway rail magnetic system 530 including guideway rail levitation magnetic field generators 315 and first guideway rail propulsion magnetic field generators 405. The first magnetic levitation motor 505 also comprises a first moving member 535 that comprises a first moving member magnetic system 540 including first moving member levitation magnetic field generators 320 and first moving member propulsion magnetic field generators 410. The second magnetic levitation motor 510 comprises a second guideway rail 545 that includes a second guideway rail magnetic system 550 including second guideway rail levitation magnetic field generators 315 and second guideway rail propulsion magnetic field generators 405. The second magnetic levitation motor 510 also comprises a second moving member 555 that comprises a second moving member magnetic system 560 including second moving member levitation magnetic field generators 320 and second moving member propulsion magnetic field generators 410.

A connector arm 565 can be provided to selectively connect first magnetic levitation motor 505 and/or the second magnetic levitation motor 510 to the transporter body 160. In the particular version of FIG. 5, the transporter body 160 is connected to the second magnetic levitation motor 510, and the connector arm 565 selectively connects the first magnetic levitation motor 505 to the second magnetic levitation motor 510. Accordingly, when the transporter body 160 is being moved under the control of the second magnetic levitation motor 510, the connector arm 565 can be disengaged, and when the transporter body 160 is being moved by the first magnetic levitation motor 505 or by both the first magnetic levitation motor 505 and the second magnetic levitation motor 510, the connector arm 565 can be engaged. Alternatively, when the transporter body 160 is only under the control of the second magnetic levitation motor 510 or is predominantly under the control of the second magnetic levitation motor 510, the connector arm 565 can be engaged but with the first magnetic levitation motor 505 providing no or reduced propulsion to the transporter body 160. In an alternative version, the connector arm 165 can directly connect the first magnetic levitation motor 505 to the transporter body 160 and/or separate connector arms can be provided for each of the first magnetic levitation motor 505 and the second magnetic levitation motor 510 so that each can be independently connected to the transporter body 160.

The first guideway rail 525 and the second guideway rail 545 can extent along parallel and/or non-parallel paths. For example, in one version, both the first guideway rail 525 and the second guideway rail 545 can extend generally parallel together from a first transfer station to a second transfer station. Optionally, the second guideway rail 545 can diverge as an off-shoot at one or more of the transfer stations so that the transporter body 160 or at least a portion of the transporter body 160 can travel along a second path. For example, the second path can lead the transporter body 160 to one or more locations not on the path of the first guideway rail 525, such as a city location and/or an airport.

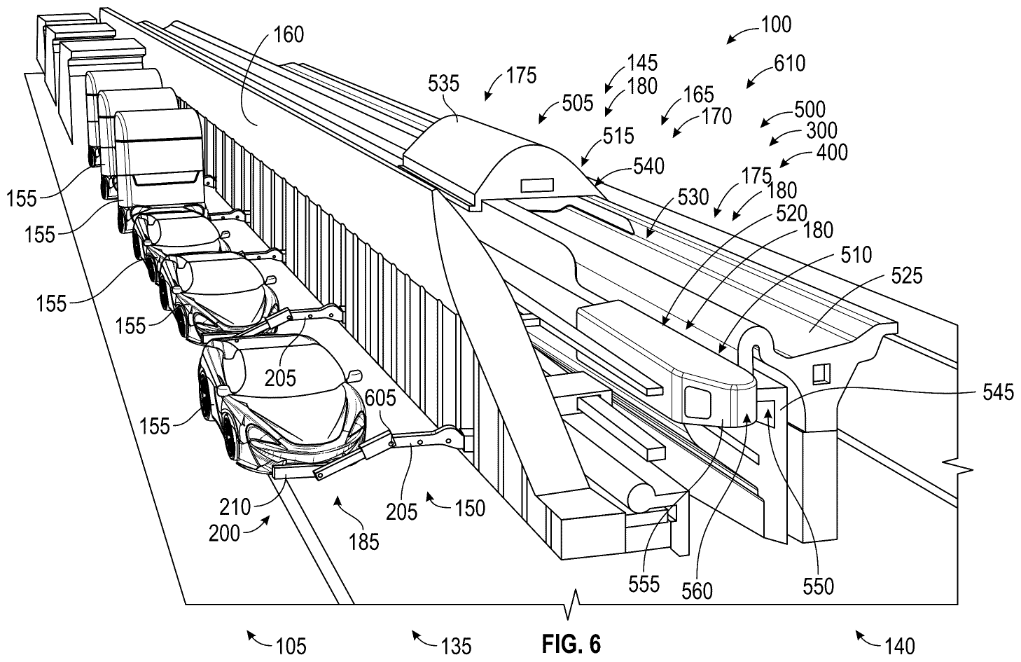

A particular version of a vehicle transporting system 100 of the invention is illustrated in FIG. 6. In this version, the vehicle coupling system 150 has a plurality of coupling arms 205 that extend from the transporter body 160 so that a plurality of vehicles can be coupled to the transporter body 160. This allows a plurality of vehicles 155 to be transported by the vehicle transporting system 100 at the same time. The coupling arms 205 of the version of FIG. 6 include a latching mechanism 210 that is adapted to latch onto the front bumper or other part of the vehicles 155 and can include one or more joints 605 or hinges to allow the position and/or height of the coupling arm 205 to be adjustable to the size of a vehicle 155. In one particular version, the latching mechanism 210 can be a Scharfenberg coupler or modification thereof.

The version of FIG. 6 of the vehicle transporting system 100 also shows the interaction of the multi-motor system 500. The first magnetic levitation motor 505 and/or the second magnetic levitation motor 510 can include one or more of permanent magnets, superconducting magnets, superconducting coils, and/or the like. The vehicle transportation system 100 can include a regenerative braking system 610 that is associated with the first magnetic levitation motor 505, the second magnetic levitation motor 510, and/or the transporter body 160 that generates power as braking occurs by taking advantage of the large amounts of momentum of the moving parts. In one version, linear generator permanent magnets are stationary along one or both of the guideways, and coils move with the moving members. In the version of FIGS. 6, the magnets form or are on a stationary track that runs along the system, and the coils form or are on a C-shaped or horseshoe-shaped member that at least partially covers the magnets. In another version, the linear generator permanent magnets can be in the form or on one or more rails that extend along the ground or below a moving part of the system, such as a platform, and the coils can be one or more downward facing C-shaped or horseshoe shaped members that extend from a moving part system and at least partially cover the magnets.

The vehicle transport system 100 of FIG. 6 functions on the push-pull principles offered by the special configuration of super conductive magnets. The vehicle transport system 100 can use linear induction and/or linear synchronous motors that use neodymium-iron boron permanent magnets in a Halback Array configuration for levitation. The propulsion is provided by a linear synchronous motor. Propulsion is either linear induction motor active propulsion from the guideway or linear synchronous passive propulsion from the moving platform. The guideway system 165 can be constructed of steel box girders with concrete deck slabs, tubular steel space truss, and precast, prestressed concrete U girder with precast concrete deck panels. The guideway rail 170 can be constructed of hot rolled, corrosion resistant steel, joint plate forging steel, and sleeper square pipe steel. The primary magnets react with a thin aluminum reaction plate (rotor) installed along the top surface of the levitation rail to propel the moving members 175. The high speed motor can have a body and levitation motors, either a linear induction motor or a linear synchronous motor. The main frame structure can be made of aluminum alloy with finer-reinforced plastic with a thin aluminum plate, semi-monocoque construction, like an airplane fuselage which has frames, stringers, and skin panels. The low speed motors have a body, levitation motors which can be a linear induction motor or a linear synchronous motor, a main frame structure which can be made of aluminum alloy with fiber-reinforced plastic with a thin aluminum plate, semi-monocoque construction, like an airplane fuselage which has frames, stringers, and skin panels. The vehicle transport or moving platform has a body, neodymiun-iron boron permanent magnets in a Halbach Array configuration for levitation, a Linear Induction Generator or Linear Synchronous Generator provides DC electric power to the entire system. The linear generator includes a main frame structure that can be made of aluminum alloy with aluminum honeycomb panels, an active 3-phase copper or aluminum winding of the stator produces a traveling magnetic field, and a steel pole with permanent levitation magnets. The coupling arm 150 can be made of aluminum alloy or aluminum honeycomb panels or steel.

A detailed version of the use of the vehicle transporting system 100 will be described, though the invention is not intended to be limited to this use or type of use. However, one or more steps described herein, in any order or combination, may make up a process of the invention. A user can book a departure time and on-boarding location online, by app, by phone, in person at the on-boarding location, or otherwise. The user drives the vehicle 155 to be transported to the on-boarding location, which can be a departure terminal. The user locates and approaches a designated terminal or on-boarding position which can have necessary accommodations to support and assist the user. A transit attendant or mechanism can inspect the vehicle 155 for safety issues and/or certify the vehicle 155 for transport. The vehicle 155 would then be coupled to the vehicle coupling system 150 in any of the manner described herein. The user would then turn off the engine of the vehicle 155 and place the vehicle in neutral if a tow coupling system 200 is being used. Optionally, if the vehicle 155 is an electric vehicle, it can be hooked up to a charging system to charge the electric vehicle during the transport. The vehicle coupling system 150 can be filled with 1 to 10 or any other number of vehicles. Initially at departure from the on-boarding location, the low speed motor will taxi the system and will connect with the high speed motor. Optionally, multiple transporter bodies can be connected to one another like rail cars. The high speed motor then propels the system to the off-boarding location as it levitates on the guideway. At or near the off-boarding location, the high speed motor will disengage, and the low speed motor will taxi to the final off-boarding location where the vehicle 155 can be decoupled from the vehicle coupling system 150 and the user can drive away in the vehicle 155.

The transporter body 160 and the motor system 145 have several advantages. For example, the motor system can function with six degrees of freedom, and the transporter body 160 can be driven by two or more motors. The transporter body 160 can accommodate more than one linear generator for power requirements. The first magnetic levitation motor 505 and/or the second magnetic levitation motor 510 can be mounted on the transporter body 160 on the side for low speed urban areas because of limited space for the vehicles to travel. The transporter system can be mounted vertically to prevent the accumulation of snow and ice or debris which could cause delays to the system 100.

In another version, the vehicle transporting system 100 can make use of both sides of the guideway rail 170. For example, in a first version, a first transporter body 160 can be provided on one side of the guideway rail 170, and a second transporter body 160 can be provided on the opposite side of the guideway rail 165. In another version, a first transporter body 160 and motor system 145 can be provided on one side of the vehicle transporting system 100, and a second transporter body 160 and motor system 145 can be provided on the opposite side of the first transporter body 160 and motor system 145. The second transporter body 160 and motor system 145 can run beside and parallel to the first transporter body 160 and motor system 145 and can transport vehicles in the same or in the opposite direction as the first transporter body 160 and motor system 145.

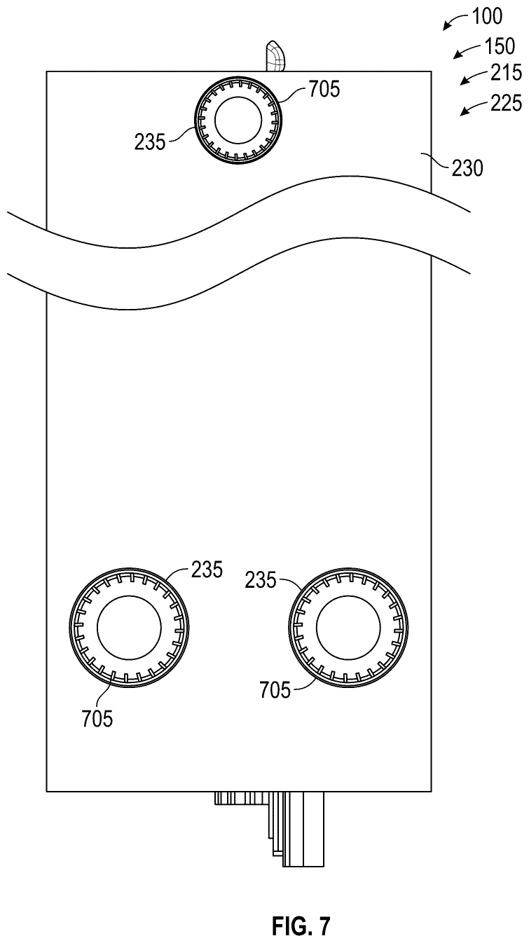

FIG. 7 shows a version of a vehicle coupling system 150 of the vehicle transporting system 100 in which the coupling system 150 is a vehicle supporting system 225 comprising a support platform 230. In this version, the support platform 230 comprises wheels 235 that are retractable wheels 705 in that the retractable wheels can be selectively moved into engagement, such as by being rotated 180 degrees. When moved into engagement, the retractable wheels 705 can support or help to support the platform 230. When the retractable wheels 705 are moved out of engagement, the platform 230 can be elevated mechanically or by a platform levitation system, as shown in examples hereinbelow.

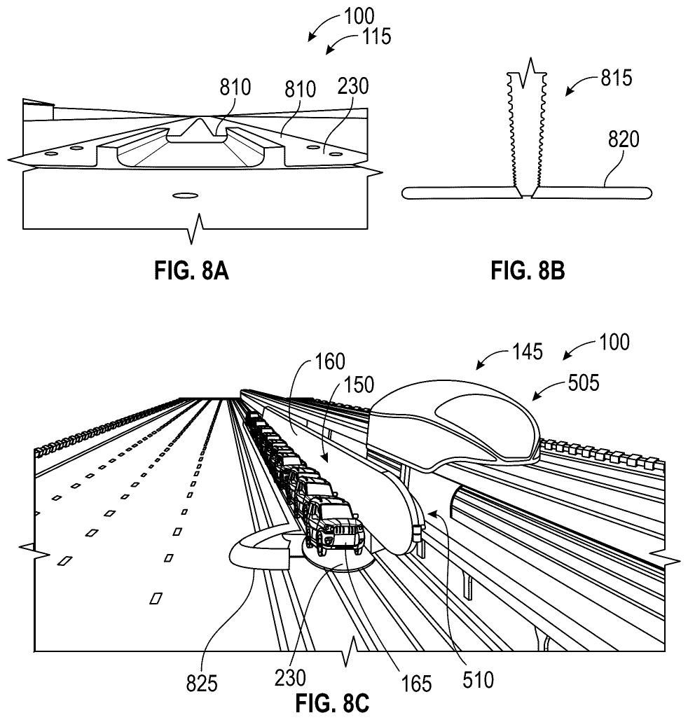

FIGS. 8A, 8B, and 8C show a version of a vehicle coupling system 150 of the vehicle transporting system 100 in which the coupling system 150 is a vehicle supporting system 225 comprising a support platform 230. In this version, the support platform 230 is adapted to accommodate a plurality of vehicles 155, as shown in FIG. 8C. FIGS. 8A and 8B illustrate a version of an anchoring system 800 that can be used to secure the vehicles 155 to the platform 230. In the particular version shown, the top 805 of the support platform 230 includes a longitudinal slot or channel 810 that can receive a T-bar 815 that is coupleable with each vehicle 155 such as by being attached to the undercarriage or bumper of the each vehicle 155. The T-bar 815 has a transversely extending bar portion 820 that is receivable within the longitudinal slot or channel 810. As can be seen in FIG. 8C, a plurality of vehicles 155 can be secured and supported on the support platform 230 which is coupled to the transporter body 160. A front gate 825 can be opened, as shown, to allow the vehicles 155 to drive off the support platform 230. Alternatively, the vehicles 155 can be secured to the support platform by another mechanism such as longitudinally extending rails that contact the wheels of the vehicles 155 or by simply applying the parking brakes or emergency brakes of the vehicles 155.

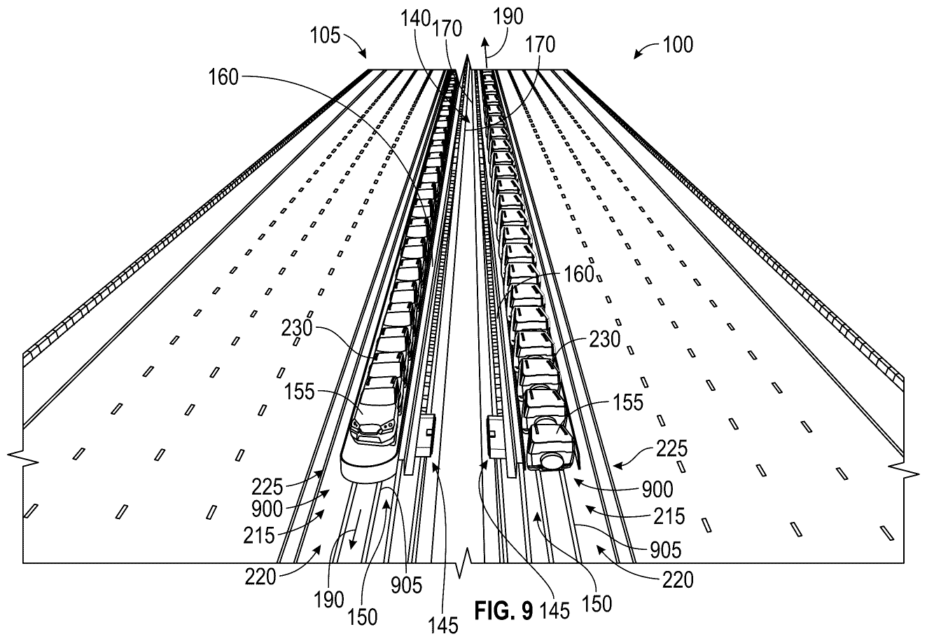

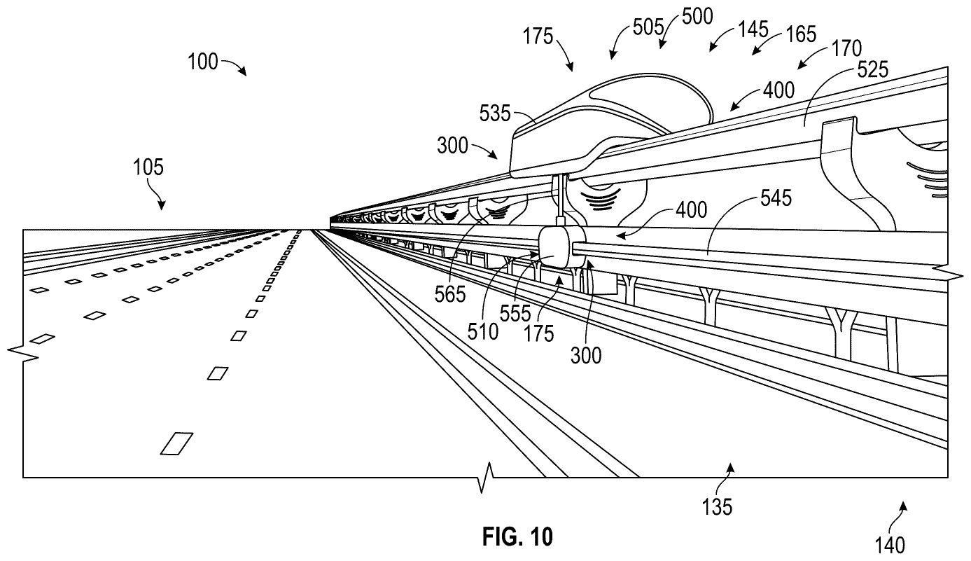

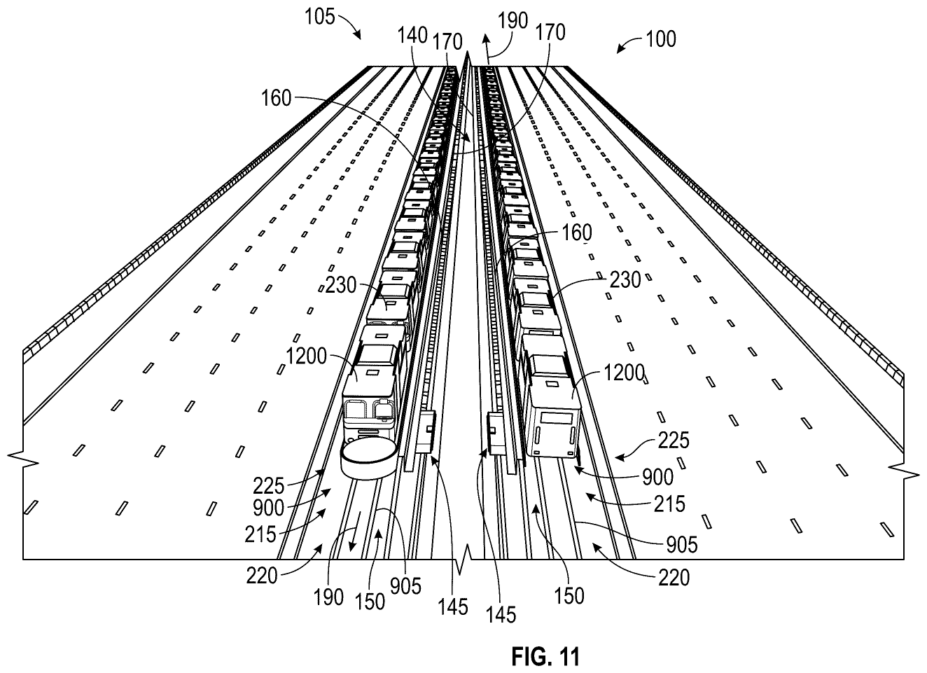

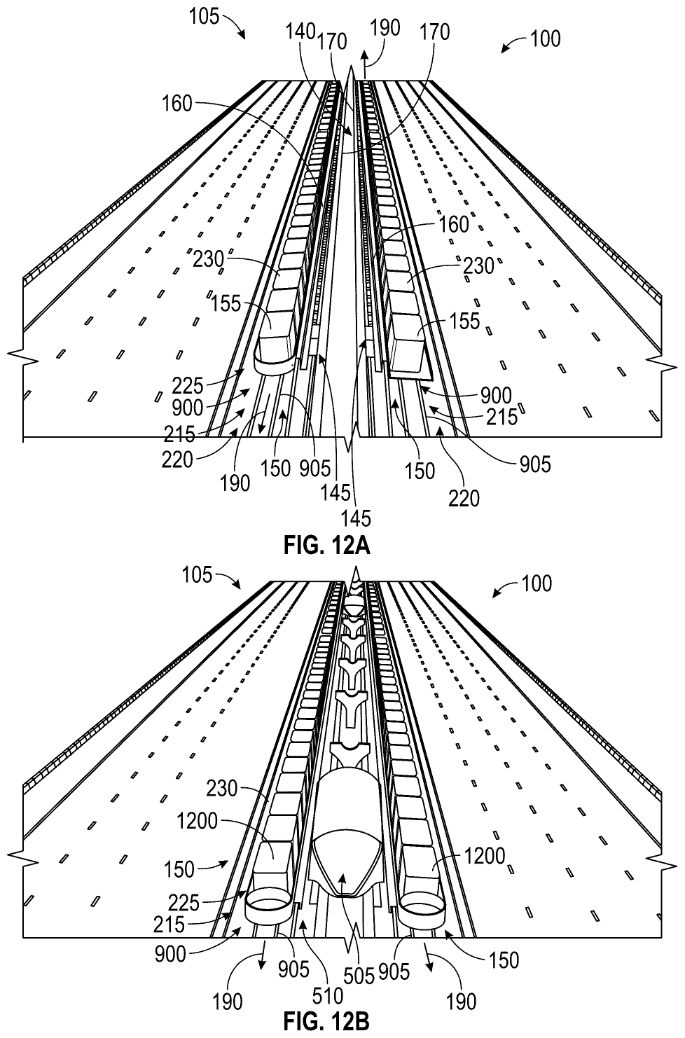

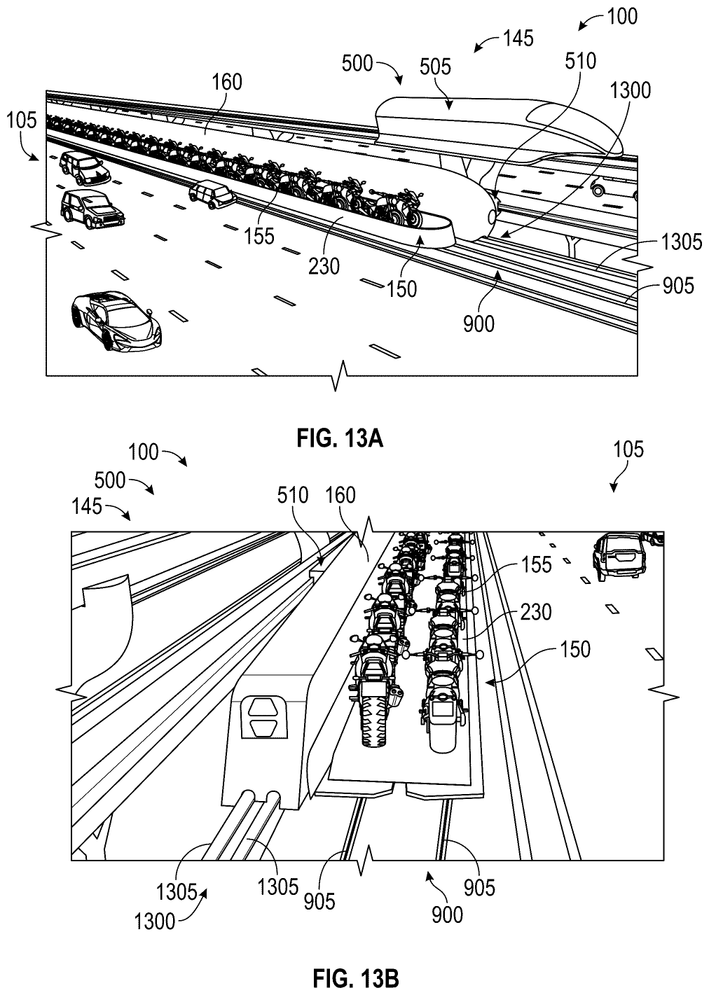

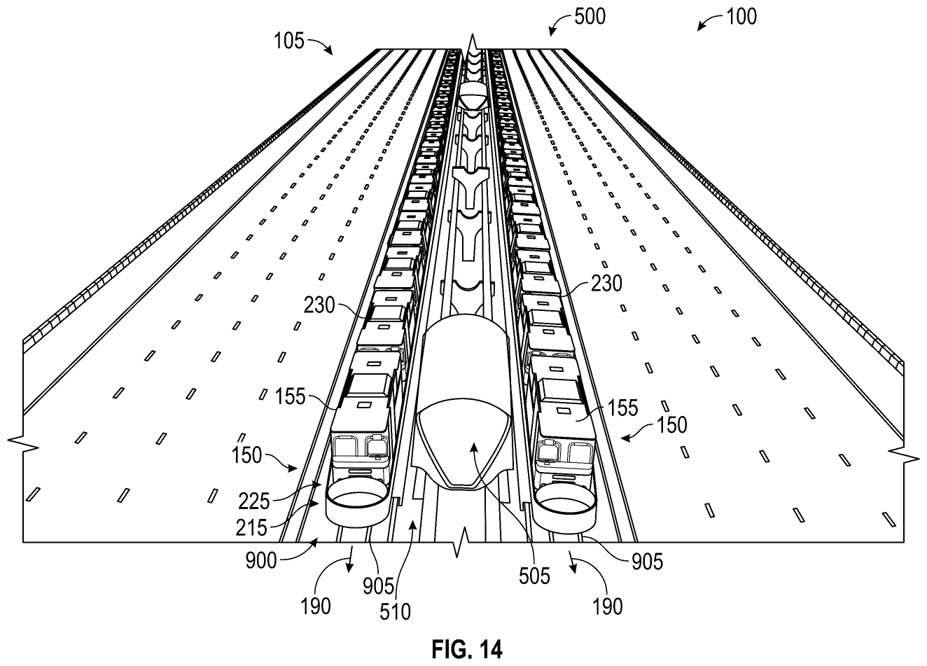

FIGS. 9-14 show various features and version of vehicle transportation systems 100 according to the invention. Each of the features shown and/or discussed can be included separately and/or in combination with any other features or versions described herein. FIG. 9 shows a version of a vehicle transportation system 100 in which only the second magnetic levitation motor 510 or low-speed motor is used. As also is shown in the version of FIG. 9, the vehicle coupling system 150 comprises a support platform 230 that is elevated by being levitated by a support platform levitation system 900. The support platform levitation system 900 uses one or more magnetic rails 905 that magnetically levitate the support platform 230 as described above. In another version, the magnetic rails 905 can be replaced by slide rails so that the support platform 230 is supported by and slides on the slide rails instead of being levitated or elevated. FIG. 11 shows the version of FIG. 9 carrying trucks, such as tractor trailers or delivery trucks. FIG. 10 shows a version of the vehicle transportation system 100 similar to the version of FIG. 5. The transporter body 160 and coupling system 150 have been removed for clarity. FIG. 12A shows a version of the vehicle transporting system 100 similar to the version of FIG. 9 but with cargo containers 1200 loaded onto the support platform 230. FIG. 12B shows the version of FIG. 12A with a high speed motor in addition to the low speed motor. FIGS. 13A and 13B show another version of a vehicle transporting system 100 of the invention. The version of FIGS. 13A and 13B is shown carrying motorcycles as the vehicles 155 but can carry any type of vehicle or other object. Also shown in the version of FIGS. 13A and 13B is a transporter body supporting system 1300. In the particular version shown, the transporter body supporting system 1300 comprises a magnetic levitation system using one or more magnetic rails 1305 that interact with the transporter body 160 to help support at least a portion of the weight of the transporter body 160. FIG. 14 shows a version of a vehicle transporting system 100 similar to the version of FIG. 11 with a high speed motor in addition to the low speed motor.

In one version, the vehicle transporting system 100 of the invention can be associated with a magnetic levitation train system. For example, the vehicle transporting system 100 can utilize at least a portion of an existing train guideway system. In another version, an existing magnetic levitation train can operate as the motor system 145 of the vehicle transporting system 100, such as by having the transporter body 160 being connected or connectable to a train car. By train car it is meant a conventional train car, such as one that includes an interior compartment that can contain passengers and/or cargo or a train car that is adapted from or similar to such as train car. In another version, the motor system 145 does not include a train car and in particular does not have an interior space for containing passengers and/or cargo.

### EXAMPLES

The following are various examples and/or case studies associated with various versions of a vehicle transporting system 100 of the invention referred to in some of the examples as the Aeridu Swift. The examples highlight various potential aspects of, advantages of, observations of, and/or results of the vehicle transporting system 100.

### Example: Wireless Charging Decks

The Aeridu Swift transported decks are equipped with a wireless charging system for charging electric vehicles during transport and to power the commuter's vehicles, ensuring their ultimate comfort. This innovative feature enhances the system's value proposition by integrating convenience, efficiency, and sustainability into the commuter experience. Key Features: (1) Wireless Charging System: (i) Convenience: The wireless charging system eliminates the need for physical cables and connectors, allowing for a seamless charging experience for electric vehicles during transport; (ii) Efficiency: By providing continuous power to electric vehicles while in transit, the system ensures that vehicles are charged and ready to use upon arrival, maximizing travel efficiency and reducing downtime; (iii) Safety: Wireless charging reduces the risk of accidents related to physical connectors, ensuring a safer environment for commuters and their vehicles. (2) Comfort and Utility: (i) Vehicle Power Maintenance: The wireless charging system also supplies power to commuter vehicles, allowing occupants to use onboard systems such as climate control, entertainment, and other electronic devices without draining the vehicle's battery; (ii) Enhanced Comfort: Maintaining the power supply to vehicles during transport ensures that commuters can enjoy a comfortable journey with all necessary amenities functioning optimally. Benefits: (1) Sustainability: (i) Promotion of Electric Vehicles: By supporting the charging of electric vehicles, the Aeridu Swift system encourages the use of environmentally friendly transportation options, contributing to reduced emissions and a lower carbon footprint; (ii) Energy Efficiency: Integrating wireless charging into the transport system optimizes energy use, reducing the overall energy consumption compared to conventional charging methods. (2) User Experience: (i) Seamless Integration: The wireless charging system provides a hassle-free solution for commuters, enhancing the overall user experience by removing the need for manual charging procedures; (ii) Enhanced Convenience: Commuters can travel long distances without worrying about the battery levels of their electric vehicles, knowing they will arrive at their destination with a fully charged battery. (3) Operational Efficiency: (i) Time-Saving: Charging vehicles during transport saves time for commuters, as they do not need to stop for charging sessions before or after their journey; (ii) Optimized Transport: The ability to charge multiple vehicles simultaneously ensures that the transport system operates at maximum efficiency, catering to a larger number of commuters and reducing the demand for stationary charging infrastructure. (4) Market Differentiation: (i) Competitive Edge: The integration of a wireless charging system sets the Aeridu Swift apart from other transportation systems, offering a unique selling point that attracts environmentally conscious and tech-savvy commuters; (ii) Increased Adoption: The added convenience and sustainability features can drive higher adoption rates among commuters, leading to increased usage and revenue for the transportation system. Conclusion: The integration of a wireless charging system into the Aeridu Swift transported decks represents a significant advancement in modern transportation. By providing a seamless, efficient, and sustainable charging solution for electric vehicles during transport, the Aeridu Swift enhances commuter convenience and comfort, promotes the use of green technologies, and optimizes operational efficiency. This innovative feature not only improves the overall user experience but also contributes to the system's sustainability goals, positioning the Aeridu Swift as a leading solution in the future of transportation.

### Example: Scaleable Energy Creation

The Aeridu Swift takes the continuous activity of human movement and transforms it into a sustainable solution for generating energy, such as by utilizing a regenerative braking system. By leveraging the constant flow of commuter traffic, Aeridu Swift effectively converts kinetic energy into electric power, providing a groundbreaking approach to energy production that is inherently tied to daily human activities.

Key Features of the Aeridu Swift System: (1) Environmental Conservation: (i) Reduced Emissions: Aeridu Swift replaces traditional, fuel-consuming modes of transportation with an electric-powered system, drastically reducing greenhouse gas emissions and air pollution; (ii) Lower Noise Pollution: The system operates quietly compared to conventional vehicles and aircraft, contributing to a more serene environment, especially in urban areas. (2) Sustainable Energy Production: (i) Kinetic Energy Conversion: The system's linear generators convert the kinetic energy of moving vehicles into electrical energy, ensuring a continuous and reliable energy supply that scales with commuter activity; (ii) Renewable Integration: This energy production method can be augmented with other renewable energy sources, like solar and wind, to enhance overall sustainability. (3) Technological Innovation: (i) Advanced Maglev Technology: Aeridu Swift uses magnetic levitation (maglev) technology to provide a smooth, high-speed travel experience while minimizing energy loss and wear and tear on infrastructure; (ii) Smart Infrastructure: The system incorporates smart infrastructure for optimal energy use and minimal waste, further enhancing its efficiency and sustainability. (4) Economic and Social Benefits: (i) Cost Savings: Over time, the system reduces fuel costs for commuters and operational costs for the transportation network, providing economic benefits to both individuals and society (ii) Improved Quality of Life: Faster and more reliable transportation reduces travel time and stress, improving the overall quality of life for commuters; (iii) Job Creation: The construction, maintenance, and operation of the Aeridu Swift system generate employment opportunities across various sectors, from engineering and manufacturing to operations and customer service. Conclusion: Aeridu Swift is a transformative transportation and energy solution that harnesses the power of human movement to produce clean energy. By integrating advanced technologies and sustainable practices, Aeridu Swift offers a comprehensive approach to reducing environmental impact while meeting the growing demand for efficient and reliable transportation. This innovative system not only addresses current environmental challenges but also sets a precedent for future developments in urban mobility and energy production.

### Example: Transporter T-Bar Attachments and Vehicle Coupler System

The Aeridu Swift transportation system incorporates an innovative T-bar attachment and vehicle coupler system designed to ensure secure and efficient vehicle transport. This system allows commuters to seamlessly connect their vehicles to the transporter deck, providing a secure attachment while maximizing the efficiency of vehicle spacing during transit. Key Features: (1) T-Bar Attachments: (i) Design and Functionality: The T-section of the attachment system is engineered to slide under the deck feature of the transporter. This design allows the vehicle to be driven to the connection point and automatically coupled to the transporter deck; (ii) Automated Attachment: Once the vehicle reaches the designated connection point, the coupling system automatically engages, securely attaching the vehicle to the transporter deck. (2) Vehicle Coupler System: (i) Automatic Positioning: After attachment, the system moves the vehicle into its designated location on the transporter deck automatically, ensuring optimal spacing and secure attachment; (ii) Efficient Spacing: The system is designed to maximize the efficiency of vehicle spacing on the transporter deck, accommodating more vehicles and ensuring stability during transit. (3) Secure and Stable Transport: (i) Robust Locking Mechanism: The coupler system includes a robust locking mechanism that secures the vehicle in place, preventing any movement during transport, (ii) Enhanced Stability: By securing vehicles firmly, the system minimizes the risk of lateral or longitudinal movement, ensuring a stable and comfortable ride for passengers. Benefits: (1) Enhanced Safety: (i) Secure Attachment: The automated coupling system ensures that vehicles are securely attached to the transporter deck, preventing any risk of detachment or movement during transit; (ii) Stable Transport: The system's design enhances stability, reducing the risk of accidents and improving overall safety for passengers and vehicles. (2) Operational Efficiency: (i) Quick and Easy Attachment: The automatic coupling and positioning system allows for quick and easy attachment of vehicles, reducing loading and unloading times, (ii) Optimal Vehicle Spacing: The system's ability to maximize vehicle spacing on the transporter deck increases the efficiency of each trip, allowing for more vehicles to be transported simultaneously. (3) User Convenience: (i) Seamless Operation: The automated system simplifies the process of attaching and positioning vehicles, making it user-friendly and convenient for commuters, (ii) Compatibility: The T-bar attachment and coupler system are designed to accommodate a wide range of vehicle types, including family cars, commuter buses, and intermodal freight, ensuring broad usability. (4) Market Appeal: (i) Unique Selling Proposition: The combination of secure attachment, efficient spacing, and automated operation makes the Aeridu Swift system highly appealing to safety-conscious and environmentally-aware consumers; (ii) Customer Confidence: The emphasis on safety and operational efficiency builds customer confidence, enhancing the overall attractiveness of the Aeridu Swift transportation system. Conclusion: The Aeridu Swift's transported T-bar attachments and vehicle coupler system represent a significant innovation in secure, high-speed transportation. By allowing vehicles to automatically attach and position themselves on the transporter deck, this system ensures optimal spacing, enhanced safety, and operational efficiency. The user-friendly design and robust construction make the Aeridu Swift an ideal choice for commuters seeking a reliable and efficient transportation solution.

### Example: Speed Transportation System

The Aeridu Swift with a low-speed transportation system presents a range of potential applications and benefits. Applications: (1) Urban Public Transportation: (i) Transport Commuter Buses: Efficiently transporting commuters within cities and urban areas; (ii) Last-Mile Connectivity: Providing convenient access to public transit hubs, reducing reliance on personal vehicles. (2) Family Transportation: (i) Transport Family Vehicles: Facilitating safe and reliable transportation for families, especially in urban and suburban environments. (3) Freight Transport: (i) Transport Intermodal Freight: Supporting the movement of goods within city logistics networks, improving supply chain efficiency. (4) Tourism and Leisure: (i) Transport Tourist Shuttles: Offering a comfortable and scenic mode of transport for tourists in city centers and tourist hotspots, (ii) Leisure Transport: Connecting parks, recreational areas, and cultural sites. Benefits: (1) Scalability and Interoperability: (i) Modular Design: Easily scalable to meet varying demands, from small-scale local routes to extensive city networks, (ii) Interoperability: Compatible with existing transport systems, allowing seamless integration with other modes of transport, (iii) Efficiency and Speed: High-Speed Motors: When needed, the system can be upgraded with high-speed motors for faster transit, reducing travel time, (iv) Reduced Congestion: By offering an alternative to personal vehicle use, it can help alleviate traffic congestion in urban areas. (3) Environmental Impact: (i) Reduced Emissions: Promotes the use of electric or hybrid transport solutions, contributing to lower greenhouse gas emissions, (ii) Sustainable Urban Mobility: Supports the development of sustainable and eco-friendly urban transportation networks. (4) Versatility: (i) Multiple Vehicle Types: Accommodates various vehicle types, from family cars to buses and freight containers, enhancing its utility, (ii) Adaptability: Can be tailored to different geographical and infrastructural needs, from dense urban centers to suburban areas. (5) Safety and Reliability: (i) Secure Transport: Ensures the safe transit of passengers and goods, with advanced safety features, (ii) Reliable Operation: Designed for consistent and dependable service, minimizing disruptions and delays. By addressing these diverse applications and offering significant benefits, the Aeridu Swift low-speed transportation system has the potential to transform urban mobility and logistics, making cities more connected, efficient, and environmentally friendly.

### Example: Low Speed Coupler

The Aeridu Swift version with high-speed motor landing gear coupler, which extends from the high-speed motor and attaches to the low-speed motor and transporter, offers several significant benefits. These benefits can be categorized into operational efficiency, safety, flexibility, and maintenance advantages. Operational Efficiency: (1) Seamless Transition Between Speeds: (i) Smooth Acceleration and Deceleration: The coupler enables a smooth transition from low-speed to high-speed operations and vice versa, optimizing the overall journey time, (ii) Energy Efficiency: Efficient coupling and decoupling reduce energy consumption during speed transitions. (2) Enhanced Performance: (i) Optimized Power Usage: The ability to switch between motors based on speed requirements ensures optimal power usage and performance, (ii) Consistent Speed Maintenance: Ensures consistent speed maintenance during different phases of the journey, improving overall transport efficiency. Safety: (1) Secure Attachment: (i) Stable Coupling: The landing gear coupler ensures a stable and secure connection between the high-speed motor, low-speed motor, and transporter, reducing the risk of decoupling, (ii) Enhanced Stability: Provides additional stability to the transport system, especially during high-speed operations, (iii) Safety Redundancy: Fail-Safe Mechanisms: Incorporates fail-safe mechanisms that ensure the safety of the transport system in case of mechanical issues, (iv) Improved Handling: Enhances handling and control of the transporter, particularly during acceleration and deceleration phases. Flexibility: (1) Versatile Operations: (i) Adaptability: Allows for flexible operations by easily switching between different motors based on operational requirements, (ii) Scalability: Facilitates scalability by enabling the addition of more transporters or motors as needed. (2) Intermodal Integration: (i) Multi-Mode Transport: Supports the integration of various transport modes, making it easier to adapt to different cargo types and operational scenarios, (ii) Operational Versatility: Enhances the ability to handle different operational demands, such as varying cargo loads and passenger volumes. Maintenance and Longevity: (1) Reduced Wear and Tear: (i) Minimized Stress: By distributing the load between high-speed and low-speed motors, the coupler reduces the stress on individual components, extending their lifespan, (ii) Lower Maintenance Costs: Decreased wear and tear lead to lower maintenance costs and less frequent repairs. (2) Simplified Maintenance: (i) Easy Access: The design of the coupler allows for easy access to critical components, simplifying maintenance and inspections, (ii) Efficient Repairs: Facilitates quick and efficient repairs, reducing downtime and improving operational continuity. Economic Benefits: (1) Cost Efficiency: (i) Reduced Operational Costs: Optimized energy usage and reduced maintenance needs contribute to lower overall operational costs. (ii) Increased Lifespan: Prolonged lifespan of motors and transporters due to reduced wear and tear leads to cost savings over time. (2) Improved ROI: (i) Enhanced Asset Utilization: Efficient use of high-speed and low-speed motors ensures better utilization of assets, leading to a higher return on investment, (ii) Increased Capacity: The ability to scale and adapt operations to demand increases capacity and potential revenue. Environmental Impact: (1) Reduced Emissions: (i) Energy Efficiency: Improved energy efficiency reduces overall emissions, contributing to a smaller carbon footprint, (ii) Sustainable Operations: Supports sustainable transport operations by optimizing resource use and reducing environmental impact. (2) Cleaner Energy Use: (i) Electric Compatibility: The system's compatibility with electric motors enhances the use of clean energy, further reducing environmental impact. Conclusion: The high-speed motor landing gear coupler for the Aeridu Swift transportation system offers a range of benefits that enhance operational efficiency, safety, flexibility, and maintenance. By enabling seamless transitions between high-speed and low-speed operations, the coupler ensures stable, secure, and efficient transport. It also contributes to cost savings, reduced environmental impact, and improved overall performance, making it a crucial component of the Aeridu Swift system's success.

### Example: Transporting Commuter Busses

The potential benefits of the Aeridu Swift transportation system carrying commuter buses filled with passengers are multifaceted, encompassing efficiency, environmental impact, economic savings, and enhanced commuter experience. Enhanced Commuter Experience: (1) Convenience: (i) Seamless Connectivity: Commuters can board buses near their homes and remain on the bus until reaching their final destination, reducing the need for multiple transfers, (ii) Last-Mile Connectivity: Aeridu Swift can bring commuters closer to their final destinations, addressing the last-mile problem effectively. (2) Comfort: (i) Continuous Journey: Passengers stay on the same bus, avoiding the discomfort of changing vehicles, (ii) Onboard Amenities: Buses can be equipped with Wi-Fi, comfortable seating, and other amenities, improving the overall travel experience. (3) Reduced Travel Time: (i) High-Speed Transport: Aeridu Swift's high-speed capability can significantly reduce travel times compared to traditional bus routes. Operational Efficiency: (1) High CapacityL (i) Bulk Transport: The system can transport multiple buses simultaneously, increasing the number of passengers moved per trip, (ii) Flexible Scheduling: The system can accommodate varying commuter volumes, with the ability to scale up during peak times. (2) Reliability: (i) Dedicated Routes: Aeridu Swift operates on dedicated routes, reducing delays caused by traffic congestion, (ii) Consistent Timings: More predictable and consistent travel times enhance reliability for commuters. Environmental Impact (1) Reduced Emissions: (i) Electric Power: Utilizing electric power reduces greenhouse gas emissions compared to diesel-powered buses, (ii) Energy Efficiency: High efficiency of electric transport reduces the overall environmental footprint. (2) Sustainable Energy: (i) Energy Generation: Aeridu Swift can generate supplemental electrical energy, contributing to a cleaner energy grid. Economic Benefits: (1) Cost Savings: (i) Lower Fuel Costs: Electric transport is generally cheaper per mile than diesel fuel, (ii) Reduced Maintenance Costs: Electric systems typically have lower maintenance costs compared to internal combustion engines. (2) Revenue Generation: (i) Increased Ridership: Enhanced convenience and comfort can attract more commuters, increasing fare revenue. (3) Infrastructure Savings: (i) Reduced Road Wear: Fewer buses on traditional roads reduce wear and tear, lowering maintenance costs for public roadways, (ii) Optimized Infrastructure Use: Existing transportation infrastructure can be utilized more efficiently. Social and Community Benefits (1) Reduced Congestion: (i) Less Road Traffic: Fewer buses on the road contribute to reduced traffic congestion, benefiting all road users, (ii) Enhanced Urban Mobility: Improved mass transit options enhance overall urban mobility. (2) Health Benefits: (i) Improved Air Quality: Reduced emissions contribute to better air quality, with positive health impacts for the community, (ii) Reduced Noise Pollution: Electric transport is generally quieter than traditional buses, reducing noise pollution in urban areas. (3) Accessibility: (i) Improved Access: Enhanced public transport options increase accessibility for all community members, including those without personal vehicles. Economic and Developmental Benefits: (1) Job Creation: (i) New Employment Opportunities: Development, deployment, and operation of the Aeridu Swift system create jobs in engineering, construction, and operations. (2) Economic Growth: (i) Stimulated Local Economies: Improved transport links can stimulate local economies by enhancing access to businesses and services, (ii) Attraction of Investments: A modern, efficient transport system can attract businesses and investments to the area. Conclusion: The Aeridu Swift transportation system, by carrying commuter buses filled with passengers, offers numerous benefits. These range from enhancing the commuter experience and operational efficiency to delivering significant environmental and economic advantages. By reducing emissions, cutting costs, and improving connectivity, Aeridu Swift presents a forward-thinking solution to modern transportation challenges, paving the way for sustainable urban mobility and economic growth.

### Example: Intermodal Freight

The potential benefits of the Aeridu Swift transportation system carrying intermodal freight are extensive, touching on efficiency, environmental impact, economic savings, and enhanced logistics capabilities. Key benefits: Enhanced Efficiency: (1) Faster Delivery Times: (i) High-Speed Transport: Aeridu Swift's high-speed capability significantly reduces transit times compared to traditional freight transport methods, (ii) Direct Routes: Operating on dedicated guideways minimizes delays caused by traffic congestion and road conditions. (2) Increased Capacity: (i) Bulk Transport: The system can transport multiple freight containers simultaneously, increasing the volume of goods moved per trip, (ii) Scalability: The ability to couple multiple transporters allows for scaling operations to match demand. (3) Reliability: (i) Consistent Scheduling: Dedicated guideways and automated systems ensure more predictable and consistent delivery times, (ii) Reduced Delays: Minimizes delays caused by traffic, accidents, and weather conditions on traditional road networks. Environmental Impact: (1) Reduced Emissions: (i) Electric Power: Utilizing electric power instead of diesel for freight transport reduces greenhouse gas emissions, (ii) Energy Efficiency: High efficiency of electric transport systems lowers the overall environmental footprint. (2) Sustainable Energy: (i) Energy Generation: Aeridu Swift's ability to generate supplemental electrical energy can contribute to a cleaner energy grid. Economic Benefits: (1) Cost Savings: (i) Lower Fuel Costs: Electric transport is generally cheaper per mile than diesel fuel, (ii) Reduced Maintenance Costs: Electric systems typically have lower maintenance costs compared to internal combustion engines. (2) Revenue Generation: (i) Increased Freight Volumes: Enhanced efficiency and reliability can attract more freight business, increasing revenue. (3) Infrastructure Savings: (i) Reduced Road Wear: Fewer heavy trucks on traditional roads reduce wear and tear, lowering maintenance costs for public roadways, (ii) Optimized Infrastructure Use: Existing transportation infrastructure can be utilized more efficiently. Logistical and Operational Benefits: (1) Intermodal Connectivity: (i) Seamless Integration: Aeridu Swift can connect seamlessly with other transport modes (e.g., ships, rail, trucks) for efficient intermodal freight movement, (ii) Flexible Loading/Unloading: Designed to handle standard intermodal containers, simplifying logistics and reducing handling times. (2) Improved Supply Chain Management: (i) Real-Time Tracking: Advanced monitoring and tracking systems enable real-time visibility of freight, enhancing supply chain management, (ii) Reduced Inventory Costs: Faster and more reliable transport reduces the need for large inventory buffers, lowering inventory carrying costs. Social and Community Benefits: (1) Reduced Congestion: (i) Less Road Traffic: Shifting freight transport from roads to dedicated guideways reduces traffic congestion, benefiting all road users, (ii) Enhanced Urban Mobility: Reducing the number of heavy trucks on roads improves urban mobility and safety. (2) Health Benefits: (i) Improved Air Quality: Reduced emissions contribute to better air quality, with positive health impacts for the community, (ii) Reduced Noise Pollution: Electric transport is generally quieter than diesel trucks, reducing noise pollution in urban areas. Economic and Developmental Benefits: (1) Job Creation: (i) New Employment Opportunities: Development, deployment, and operation of the Aeridu Swift system create jobs in engineering, construction, and operations. (2) Economic Growth: (i) Stimulated Local Economies: Improved freight transport links can stimulate local economies by enhancing access to markets and suppliers, (ii) Attraction of Investments: A modern, efficient transport system can attract businesses and investments to the area. Technological and Innovation Benefits (1) Advanced Technology Adoption: (i) Innovation Leadership: Implementing cutting-edge transportation technology positions regions as leaders in innovation, (ii) R&D Opportunities: Continued development and optimization of the system provide ongoing research and development opportunities. (2) Infrastructure Modernization: (i) Future-Proofing: Investing in advanced transport infrastructure helps future-proof logistics capabilities against evolving market demands and technological advancements. Conclusion: The Aeridu Swift transportation system, by carrying intermodal freight, offers numerous benefits. These range from enhancing efficiency and reducing environmental impact to delivering significant economic and logistical advantages. By improving delivery times, reducing costs, and providing a scalable, reliable transport solution, Aeridu Swift presents a forward-thinking approach to modern freight transport, contributing to sustainable economic growth and enhanced supply chain resilience.

### Example: Motorcycle Pod and Hitch

The Aeridu Swift transportation system integrates advanced technology to enhance the efficiency and convenience of commuting for motorcyclists. Here's a detailed overview of the motorcycle autonomous pod attachments and coupler system, along with the operational process and its benefits. Aeridu Swift Transporter Motorcycle Autonomous Pod Attachments and Coupler System Key Features: (1) T-Bar Operation for Motorcycle Pods: (i) Sliding T-Bar Mechanism: The T in the T-Bar section of the autonomous pod slides under the deck feature on the transporter deck. This design allows motorcyclists to ride their motorcycles to the connection point, (ii) Automatic Attachment: Once the motorcycle pod reaches the connection point, the coupling system automatically attaches and secures the motorcycle pod to the transporter deck. (2) Secure and Efficient Attachment: (i) Automated Movement: The system automatically moves the motorcycle pod into the designated location on the transporter deck, ensuring secure attachment and optimal spacing, (ii) Efficient Spacing: This system maximizes the efficient use of space on the transporter deck, allowing for transporting multiple motorcycles and pods. (3) Seamless Transition and Boarding: (i) Terminal Arrival: Upon arrival at the terminal, motorcyclists leave their motorcycles with the terminal valet, (ii) Boarding Commuter Buses: Motorcyclists then board a commuter bus, which is on another transporter that is also attached to the motorcycle transporter, for the final leg of their journey. Operational Process: (1) Ride to Connection Point: (i) Motorcyclists ride to the transporter terminal. The valet then securely attaches the motorcycle to the autonomous pod at the designated connection point on the transporter deck, (ii) The T-Bar mechanism slides under the deck, aligning the motorcycle pod for attachment. (2) Automatic Coupling: (i) The vehicle coupling system engages automatically, securing the motorcycle pod to the transporter, (ii) The system then moves the motorcycle pod into its designated spot, ensuring efficient use of space and secure attachment. (3) Transport to Terminal: (i) The transporter travels to the designated terminal, (ii) Upon arrival, the motorcyclist leaves their motorcycle with the terminal valet. (4) Final Commute: (i) Motorcyclists board a commuter bus on another transporter attached to the motorcycle transporter, (ii) The commuter bus completes the last mile of the journey, bringing passengers to their final destination. Benefits: (1) Convenience: (i) Seamless Transition: The automatic coupling and movement of the motorcycle pods provide a seamless transition from riding to transport, (ii) Reduced Effort: Motorcyclists do not need to manually secure their vehicles, as the system handles it automatically. (2) Efficiency: (i) Optimal Space Utilization: The system ensures the most efficient use of space on the transporter deck, allowing for the transport of multiple motorcycle pods, (ii) Time-saving: Automated processes reduce the time required for boarding and securing motorcycles. (3) Safety: (i) Secure Attachment: The automatic coupling system ensures that motorcycles are securely attached to the transporter, reducing the risk of accidents during transport, (ii) Stable Transport: Efficient spacing and secure attachment improve the stability of the transport system. (4) Enhanced Commuter Experience: (i) Comfort: Motorcyclists can enjoy a comfortable ride on a commuter bus for the last mile of their journey, (ii) Reduced Stress: The system reduces the stress associated with manually securing motorcycles and navigating traffic. (5) Scalability: (i) Flexible Transport: The system can accommodate varying numbers of motorcycles and commuter buses, making it scalable based on demand, (ii) Integration with Other Modes: The ability to transport both motorcycles and commuter buses on the same system enhances the overall flexibility and integration of the Aeridu Swift transportation network. Conclusion: The Aeridu Swift transporter motorcycle autonomous pod attachments and motorcycle coupler system provide a highly efficient, secure, and convenient solution for transporting motorcycles. By automating the attachment and movement of motorcycle pods, the system ensures optimal space utilization and enhances the overall commuter experience. This innovative approach aligns with the Aeridu Swift's commitment to integrating advanced technology with real-world applications, promoting a seamless, efficient, and safe transportation solution.

### Example: Intermodal Scaleable Interoperability

The Aeridu Swift offers a scalable, interoperable solution by coupling the transporters and adding high-speed motors for high-speed transport. Moreover, the transporter decks can accommodate family vehicles, commuter buses, and intermodal freight. This versatility makes the Aeridu Swift system an innovative and adaptable transportation solution for various use cases. Here's how these features contribute to its efficacy. Key Features: (1) Scalability: (i) The Aeridu Swift system is designed to be scalable, allowing for the addition of more transporters and high-speed motors as needed. This ensures the system can grow in capacity to meet increasing demand without significant overhauls, (ii) The modular nature of the transporters enables easy expansion of the fleet, catering to both short-term surges and long-term growth in commuter and freight traffic. (2) Interoperability: (i) By enabling the coupling of transporters, the system maintains interoperability, allowing different units to work seamlessly together. This interoperability ensures consistent performance and ease of maintenance across the fleet, (ii) High-speed motors can be added to the system to achieve higher transport speeds, improving the overall efficiency and reducing travel times for longer distances. (3) Versatile Transporter Decks: (i) The transporter decks are designed to accommodate a variety of vehicles, including family cars, commuter buses, and intermodal freight containers. This versatility ensures that the system can serve a wide range of transportation needs, (ii) By supporting different types of cargo, the Aeridu Swift can optimize space utilization and improve the efficiency of both passenger and freight transport. Benefits: (1) Enhanced Efficiency: (i) The ability to couple transporters and add high-speed motors enhances the overall efficiency of the system, reducing the need for multiple separate trips and optimizing energy use, (ii) The system can adapt to different transportation needs, whether it's moving people quickly between cities or transporting heavy freight over long distances. (2) Environmental Impact: (i) With the potential to generate supplemental electrical energy through its linear generators, the Aeridu Swift can help power itself, (ii) The reduction in vehicle emissions by providing an alternative to traditional car travel and short-haul flights contributes significantly to environmental conservation efforts. (3) Economic Advantages: (i) The scalability and modular design of the Aeridu Swift reduce the need for extensive infrastructure investment upfront, allowing for phased development and cost-effective scaling, (ii) By accommodating a variety of vehicles, the system can attract a broader user base, including families, commuters, and businesses, thereby increasing revenue potential. (4) Reduced Congestion: (i) The Aeridu Swift system helps alleviate traffic congestion by providing an efficient alternative to road transport, especially in densely populated urban areas, (ii) The ability to transport multiple vehicles and freight simultaneously reduces the number of vehicles on the road, leading to smoother traffic flow and less environmental impact. Conclusion: The Aeridu Swift transportation system's scalable, interoperable design and versatile transporter decks make it a revolutionary solution for modern transportation challenges. By coupling transporters and integrating high-speed motors, the system can efficiently accommodate a wide range of vehicles and freight, providing a sustainable, efficient, and adaptable transportation alternative that meets the diverse needs of today's society.

### Example: Replacing Short Haul Flights

Replacing short-haul flights between airports with the Aeridu Swift transportation system can offer significant benefits across multiple dimensions, including economic, environmental, and social aspects. Economic Benefits: (1) Cost Savings: (i) For Airlines: Reducing the number of short-haul flights can save airlines money on fuel, maintenance, and crew expenses, (ii) For Passengers: Lower costs compared to short-haul flights, including reduced baggage fees and transportation to and from airports. (2) Airport Efficiency: (i) Reduces congestion at airports, allowing them to allocate more resources to long-haul flights and improving overall efficiency. (3) Job Creation: (i) New job opportunities in the construction, operation, and maintenance of the Aeridu Swift system. Environmental Benefits: (1) Reduced Emissions: (i) The Aeridu Swift, as a high-speed, energy-efficient transportation system, can significantly reduce greenhouse gas emissions compared to short-haul flights, which are less fuel-efficient per mile than long-haul flights. (2) Lower Noise Pollution: (i) Reduced noise pollution near airports and along flight paths, improving the quality of life for nearby residents. (3) Energy Efficiency: (i) The use of electric or maglev technology can lead to greater energy efficiency and less dependence on fossil fuels. Social Benefits: (1) Increased Convenience: (i) For Passengers: More frequent and reliable service with potentially less stringent security procedures and shorter boarding times compared to airports, (ii) For Communities: Improved connectivity between cities and regions, enhancing accessibility and mobility. (2) Improved Quality of Life: (i) Reduced travel time and stress associated with airport procedures, delays, and cancellations. Operational Benefits: (1) Scalability: (i) The Aeridu Swift system can be more easily scaled to match demand compared to airport infrastructure, which requires significant investment and space. (2) Flexibility: (i) The system can offer flexible scheduling and routes, accommodating dynamic passenger demands more effectively. Regional Development: (1) Balanced Development: (i) Enhances regional development by improving access to suburban and rural areas, not just urban centers, promoting balanced economic growth. (2) Land Use Efficiency: (i) Frees up valuable airport real estate for other uses, potentially leading to better land use and urban development. Technological Advancements: (1) Innovation Hub: (i) Promotes technological innovation in transportation, setting a precedent for other regions and countries to follow. (2) Enhanced Infrastructure: (i) Leads to advancements in infrastructure technology, including high-speed rail and maglev systems, benefiting broader transportation networks. Travel Efficiency: (1) Reduced Travel Time: (i) High-speed travel between airports and city centers can significantly reduce overall travel time compared to short-haul flights, which include time-consuming security checks, boarding, and taxiing. (2) Reliability: (i) More reliable travel schedules with fewer delays and cancellations compared to air travel, which is subject to weather conditions and air traffic control restrictions. Environmental Impact: (1) Sustainable Transportation: (i) Promotes the use of sustainable transportation options, reducing the carbon footprint associated with short-haul air travel. (2) Eco-friendly Infrastructure: (i) Incorporation of green technologies and practices in the construction and operation of the Aeridu Swift system. Conclusion: Replacing short-haul flights with the Aeridu Swift transportation system presents a range of benefits, from cost savings and environmental sustainability to enhanced convenience and regional development. This shift could lead to a more efficient, reliable, and eco-friendly transportation network, ultimately contributing to a better quality of life and a more sustainable future.

### Example: High Speed Outer Loop

Building a high-speed outer loop in Atlanta for the Aeridu Swift transportation system can offer a multitude of benefits across various dimensions, including economic, environmental, and social aspects. Economic Benefits: (1) Reduced Traffic Congestion: (i) The high-speed outer loop can alleviate congestion on Atlanta's existing roadways, particularly during peak hours, improving overall traffic flow. (2) Increased Productivity: (i) Reduced travel times can lead to increased productivity as commuters spend less time in transit and more time at work or with their families. (3) Job Creation: (i) The construction, operation, and maintenance of the Aeridu Swift system can create numerous jobs in engineering, construction, operations, and maintenance. (4) Boost to Local Economy: (i) Improved transportation can attract businesses and tourists, boosting local businesses and generating economic activity. Environmental Benefits: (1) Reduced Emissions: (i) By providing a cleaner alternative to traditional car travel, the Aeridu Swift can significantly reduce greenhouse gas emissions and improve air quality in the Atlanta area. (2) Energy Efficiency: (i) The system's use of linear generators and regenerative braking can enhance energy efficiency, further reducing the environmental footprint. (3) Less Urban Sprawl: (i) Efficient transportation options can promote higher density development and reduce the spread of urban sprawl, preserving green spaces and reducing infrastructure costs. Social Benefits: (1) Improved Quality of Life: (i) Faster and more reliable transportation can improve residents’ quality of life by reducing the stress and time associated with commuting. (2) Accessibility: (i) The outer loop can enhance accessibility to various parts of the city and its suburbs, providing better connectivity for all socioeconomic groups. (3) Safety: (i) With fewer cars on the road, the likelihood of traffic accidents can decrease, making travel safer for everyone. Operational Benefits: (1) Scalability: (i) An outer loop can serve as a foundation for future expansions of the Aeridu Swift system, making it easier to scale operations and extend service coverage. (2) Flexibility: (i) The system can offer flexible scheduling and routes, accommodating the dynamic needs of commuters and freight services. Regional Development: (1) Balanced Development: (i) The outer loop can encourage balanced development across the region, preventing the over-concentration of growth in the city center and spreading economic opportunities more evenly. (2) Improved Land Use: (i) By integrating with urban planning initiatives, the high-speed outer loop can lead to better land use practices and more sustainable urban development. Technological Advancements: (1) Innovation Hub: (i) Establishing a high-tech transportation system like Aeridu Swift can position Atlanta as a leader in transportation innovation, attracting further research and development investments. (2) Enhanced Infrastructure: (i) The development of a high-speed outer loop can lead to advancements in infrastructure technology, setting new standards for future projects. Conclusion: Building a high-speed outer loop in Atlanta for the Aeridu Swift transportation system promises to bring numerous benefits, including reduced congestion, economic growth, environmental sustainability, improved quality of life, and advancements in technology. These benefits collectively contribute to making Atlanta a more livable, sustainable, and economically vibrant city.

### Example: Highway 675 Environmental Impact Study

Aeridu Swift's Environmental Impact on Highway 675 in Georgia: The Aeridu Swift transportation system is designed to revolutionize commuting while minimizing environmental impact. Implementing this system along Highway 675 in Georgia can have significant positive effects on the environment, local communities, and overall sustainability. Environmental Benefits: (1) Reduction in Carbon Emissions: (i) The Aeridu Swift system uses electric-powered transporters, significantly reducing the reliance on fossil fuels, (ii) By converting human movement into electric energy, it further lowers the carbon footprint of each commute, (iii) This reduction in vehicle emissions along Highway 675 would contribute to better air quality and a decrease in greenhouse gases. (2) Decreased Traffic Congestion: (i) The introduction of a high-speed transportation alternative can alleviate traffic congestion on Highway 675, (ii) Fewer cars on the road translate to less idling and reduced emissions from conventional vehicles, (iii) This can also lead to a smoother flow of traffic, reducing the environmental impact of traffic jams. (3) Energy Efficiency and Renewable Energy: (i) The system has the ability to generate supplemental electricity through linear generators during commutes. (4) Noise Pollution Reduction: (i) Electric motors used in the Aeridu Swift system produce less noise compared to traditional internal combustion engines, (ii) Reduced noise pollution contributes to a better quality of life for residents living near Highway 675. Specific Environmental Impacts: (1) Air Quality Improvement: (i) The reduction in emissions will lead to cleaner air, benefiting public health, particularly for communities living close to Highway 675, (ii) Decreased particulate matter and nitrogen oxides can reduce respiratory issues and other health problems. (2) Land Use and Ecosystem Preservation: (i) The Aeridu Swift guideway can be integrated into existing highway infrastructure, such as medians or shoulders, minimizing the need for additional land use, (ii) This approach helps preserve natural landscapes and prevents habitat fragmentation. (3) Water Resources: (i) Reduced vehicle emissions mean fewer pollutants deposited on roadways, which can wash into local waterways during rain, (ii) Cleaner water runoff from highways can benefit local aquatic ecosystems and water quality. Implementation Considerations: (1) Construction Impact: (i) Construction of the Aeridu Swift system will need to be managed carefully to minimize temporary disruptions and environmental damage, (ii) Strategies include scheduling construction during off-peak times and using eco-friendly materials and practices. (2) Maintenance and Operations: (i) Regular maintenance of the system ensures it operates efficiently and continues to deliver environmental benefits, (ii) Monitoring the impact on local wildlife and ecosystems will help mitigate any unforeseen negative effects. Conclusion: Implementing the Aeridu Swift transportation system along Highway 675 in Georgia presents a compelling case for substantial environmental benefits. By reducing carbon emissions, alleviating traffic congestion, and generating renewable energy, the system can contribute to a cleaner, more sustainable environment. Furthermore, its innovative approach to using existing infrastructure ensures minimal disruption to the natural landscape, making it a practical and eco-friendly solution for modern transportation challenges.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/− ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A vehicle transporting system comprising:
a motor system comprising a magnetic levitation and propulsion system;
a transporter body connectable to and moveable by the motor system; and
a vehicle coupling system adapted to be coupled one or more vehicles to the transporter body,
wherein when one or more vehicles are coupled by the vehicle coupling system to the transporter body, the transporter body and the one or more vehicles can be transported from one location to another location by the motor system.

2. A vehicle transporting system according to claim 1 wherein the motor system comprises a guideway rail and a moving member that moves along the guideway rail, wherein the moving member is connectable to the transporter body.

3. A vehicle transporting system according to claim 1 wherein the motor system comprises a first magnetic levitation motor and a second magnetic levitation motor, wherein the first magnetic levitation motor has a first moveable member that moves along a first guideway rail, and wherein the second magnetic levitation motor has a second moveable member that moved along a second guideway rail.

4. A vehicle transporting system according to claim 1 wherein the motor system comprises a first magnetic levitation motor and a second magnetic levitation motor and wherein a connector arm selectively connects the first magnetic levitation motor to the second magnetic levitation motor.

5. A vehicle transporting system according to claim 1 wherein the vehicle coupling system comprises a coupling arm with a latching mechanism adapted to latch onto a vehicle.

6. A vehicle transporting system according to claim 1 wherein the vehicle coupling system is adapted to couple to a vehicle in a manner that elevates the vehicle off the ground.

7. A vehicle transporting system according to claim 1 wherein the vehicle coupling system comprises a plurality of coupling arms, each coupling arm being adapted to couple to a vehicle.

8. A vehicle transporting system according to claim 1 wherein the vehicle coupling system comprises a support platform connected to the transporter body, the support platform being adapted to support one or more vehicles.

9. A vehicle transporting system according to claim 8 wherein the support platform is connected to a right side of the transporter body relative to a direction of travel.

10. A vehicle transporting system according to claim 8 wherein the support platform comprises wheels.

11. A vehicle transporting system according to claim 8 wherein the support platform is elevated by a magnetic levitation system.

12. A vehicle transporting system according to claim 1 wherein the vehicle transporting system comprises a regenerative braking system that generates power from the braking of the vehicle transporting system.

13. A method of transporting a vehicle, the method comprising:
providing a vehicle transportation system comprising a motor system comprising a magnetic levitation and propulsion system; a transporter body connectable to and moveable by the motor system; and a vehicle coupling system adapted to be coupled one or more vehicles to the transporter body;
coupling a vehicle to the transporter body using the vehicle coupling system;
causing the motor system to move the transporter body and the vehicle coupled to the transporter body from a first location to a second location.

14. A method according to claim 13 wherein the first location is a first transfer station adapted to allow coupling and decoupling of vehicles, wherein the second location is a second transfer station adapted to allow coupling and decoupling of vehicles, and wherein the motor system comprises a guideway rail that extends from the transfer station to the second transfer station.

15. A method according to claim 13 wherein the step of coupling a vehicle to the transporter body comprises latching the vehicle onto a coupling arm.

16. A method according to claim 13 wherein the step of coupling a vehicle to the transporter body comprises positioning the vehicle on a support platform.

17. A method according to claim 13 further comprising generating power during braking of the vehicle transporting system.

18. A method according to claim 17 wherein the generated power is provided as a charging station to the vehicle being transported.

19. A method of transporting a vehicle, the method comprising:
driving a vehicle to a first transfer station;
coupling the vehicle to a transporter body;
moving the transporter body by a magnetic levitation motor system from the first transfer station to a second transfer station;
decoupling the vehicle from the tranporter body; and
driving the vehicle away from the second transfer station.

20. A method according to claim 19 wherein the step of moving the transporter body comprises moving the transporter body at least a portion of distance from the first transfer station to the second transfer station with a first magnetic levitation motor and moving the transporter body at least a portion of the distance from the first transfer station to the second transfer station with a second magnetic levitation motor.
